(19) United States
(12) Patent Application Publication
(10) Pub. No.: US 2018/0120097 A1
(43) Pub. Date: May 3, 2018

(54) Method For Determining Depth

(71) Applicant: Siemens Aktiengesellschaft, Muenchen (DE)

(72) Inventor: Anton Schick, Velden (DE)

(73) Assignee: Siemens Aktiengesellschaft, Muenchen (DE)

(21) Appl. No.: 15/565,994

(22) PCT Filed: Jan. 11, 2016
(86) PCT No.: PCT/EP2016/050372

§ 371 Date: Oct. 12, 2017

(30) Foreign Application Priority Data
Apr. 22, 2015 (DE) 10 2015 207 328.9

(51) Int. Cl. G01B 11/24; G01B 11/25; G01B 9/02

(52) U.S. Cl. CPC G01B 11/24; G01B 9/02007; G01B 11/254

(57) ABSTRACT

The present disclosure relates to measuring depth of a feature or an object. Teachings thereof may be embodied in a method for optically determining the depth of an object. For example, a method may include: generating a measurement beam and a reference beam with a first coherent light source; projecting an optical pattern with the measurement beam onto a surface of the object; superposing the measurement beam reflected by the surface with the reference beam; recording a first image resulting from the superposition; recording a second image; and determining the depth of the object by evaluating the first and second images. For the recording of the second image, rather than using the first coherent light source, a second coherent light source may be used for generating the measurement beam and the reference beam, the second coherent light source incoherent with respect to the first.

### CROSS-REFERENCE TO RELATED APPLICATIONS

This application is a U.S. National Stage Application of International Application No. PCT/EP2016/050372 filed Jan. 11, 2016, which designates the United States of America, and claims priority to DE Application No. 10 2015 207 328.9 filed Apr. 22, 2015, the contents of which are hereby incorporated by reference in their entirety.

### TECHNICAL FIELD

The present disclosure relates to measuring depth of a feature or an object. Teachings thereof may be embodied in a method for optically determining the depth of an object.

### BACKGROUND

To determine the depth of an object and/or to topographically capture at least a partial region of the object, an optical pattern can be projected onto a surface of the object. Based on the projected pattern, which is reflected by the surface of the object and recorded, the depth may be triangulated. In the prior art to date, the projected pattern, which is reflected by the surface of the object and recorded, loses contrast and sharpness due to ambient light prevailing at the site of the object. This makes depth determination of the object difficult or even impossible.

To remedy the above-mentioned problem, some systems at least partially suppress the ambient light by way of narrowband optical filters. However, nearly the entire output of the light used for the projection is concentrated within a narrow frequency interval. Corresponding safety measures for a user may have to be implemented as a result.

When determining the depth of partially transparent objects, for example during depth determination of organic tissue, it may exhibit volume scattering which forms an undesired background. As a result, the optical pattern can smear, with the result that characteristic features of the projected optical pattern disperse in a manner such that their original positions with respect to the projected pattern can be identified only with difficulty. In particular in minimally invasive surgery, for example in laparoscopic surgery, the problem of volume scattering is important and must not be neglected.

To address this problem, some systems attempt to match the wavelength of the light used for the depth determination to the object such that the wavelength-dependent volume scattering becomes as small as possible. For example, blue light is sometimes used for depth determination of the liver. However, a light source used for depth determination must be adapted to the object, and consequently the wavelength is no longer freely selectable. In addition, the problem of volume scattering still occurs in color-coded depth determinations due to the plurality of wavelengths being used.

### SUMMARY

The teachings of the present disclosure may improve the depth determination of an object and reduce the influence of ambient light on the depth determination of the object. For example, a method for determining the depth of an object (10) may include: providing a capture apparatus (2), a calculation apparatus (3) and a projection apparatus (4), which comprises at least one first coherent light source (41); generating a measurement beam (101) and a reference beam (102) using the projection apparatus (4) and the first coherent light source (41); projecting an optical pattern (104), generated from the measurement beam (101), onto a surface of the object (10) by way of the projection apparatus (4); superposing (111) the measurement beam (105), which is reflected by the surface, with the reference beam (102); recording a first image (610), generated due to the superposition (111), by way of the capture apparatus (2); recording a second image (620) using the capture apparatus (2); and determining the depth of the object by way of evaluation of the first and second images (610, 620) by the calculation apparatus (3), wherein, for the recording of the second image (620): rather than using the first coherent light source (41), a second coherent light source (42), which is incoherent with respect to the first coherent light source, is used for generating the measurement beam (101) and the reference beam (102); or the phase difference between the measurement beam (101) and the reference beam (102) of the first coherent light source (41) is changed using a phase shifter (8).

In some embodiments, a subtraction (642) of the first and second images (610, 620) takes place for evaluating the first and second images (610, 620).

In some embodiments, a random or coded optical dot pattern is used as an optical pattern (104).

In some embodiments, a color-coded optical pattern is used as an optical pattern (104).

In some embodiments, the first and second images (610, 620) are recorded with a time lag with respect to one another.

In some embodiments, the recording of the first or second image (610, 620) is synchronized, by a control apparatus (12), with the use of the first or second coherent light source (41, 42).

In some embodiments, the recording of the first or second image (610, 620) is synchronized, by a control apparatus (12), with the change in the phase difference.

In some embodiments, a first laser is used as the first coherent light source (41) and/or a second laser is used as the second coherent light source (42).

In some embodiments, a piezotranslator or a Pockels cell is used as the phase shifter (8).

As another example, an apparatus (1) for performing the method as claimed in one of the preceding claims, may include: a capture apparatus (2), a calculation apparatus (3) and a projection apparatus (4), which comprises at least one first coherent light source (41); wherein the projection apparatus (4) comprises a first beam splitter (44) which is configured to generate, by way of the first coherent light source (41), a measurement beam (101) and a reference beam (102); wherein the projection apparatus (4) is furthermore configured to project an optical pattern (104), which is generated using the measurement beam (101), onto a surface of an object (10); wherein a second beam splitter (24) is provided, which makes possible superposition (III) of the measurement beam (105), which was reflected by the surface of the object (10), and the reference beam (102); wherein the capture apparatus (2) is configured to record a first image (610), generated by the superposition (111), and a second image (620); wherein the calculation apparatus (3) is configured to evaluate the first and the second image (610, 620) for determining the depth of the object (10); and the apparatus (1) comprises a second coherent light source (42), which is incoherent with respect to the first coherent light source (41), or a phase shifter (8), wherein the second coherent light source (42) is provided for recording the second image (620); or wherein the phase shifter (8) is configured for changing the phase difference between the measurement beam (101) and the reference beam (102) of the first coherent light source (41).

In some embodiments, the first and/or second coherent light source (41, 42) is/are in the form of lasers.

In some embodiments, the phase shifter (8) is configured in the form of a piezotranslator or a Pockels cell.

In some embodiments, the first and/or second beam splitter (44, 24) is/are configured in the form of a splitter mirror.

### BRIEF DESCRIPTION OF THE DRAWINGS

Further advantages, features, and details of the teachings herein can be gathered from the exemplary embodiments described below and on the basis of the drawings, in which, schematically:

FIG. 1 shows an apparatus for performing the method in accordance with the teachings of the present disclosure, comprising a phase shifter;

FIG. 2 shows a further apparatus for performing the method in accordance with the teachings of the present disclosure, comprising a first and second coherent light source; and

FIG. 3 shows an exemplary illustration of the evaluation of a first and second image.

Identical or equivalent elements in the figures can be provided with the same reference signs.

The beam profiles of light beams illustrated in the figures are exemplary and do not necessarily correspond to the physical reality.

### DETAILED DESCRIPTION

An example method for determining the depth of an object comprises the following steps:

providing a capture apparatus, a calculation apparatus, and a projection apparatus, which comprises at least one first coherent light source;

generating a measurement beam and a reference beam using the projection apparatus and the first coherent light source;

projecting an optical pattern, generated from the measurement beam, onto a surface of the object by way of the projection apparatus;

superposing the measurement beam, which was reflected by the surface, with the reference beam;

recording a first image, generated due to the superposition, by way of the capture apparatus;

recording a second image using the capture apparatus; and

determining the depth of the object by way of evaluation of the first and second images by the calculation apparatus, wherein, for the recording of the second image:

rather than using the first coherent light source, a second coherent light source, which is incoherent with respect to the first coherent light source, is used for generating the measurement beam and the reference beam; or

the phase difference between the measurement beam and the reference beam of the first coherent light source is changed using a phase shifter.

Here, light beams, e.g., the measurement beam and the reference beam, are considered to be a descriptive model representation, which is known to a person skilled in the art, of a real, spatially expanded light bundle. A coherent light source is a light source that generates coherent light with a coherence length such that it is capable of interference. In particular, the first and second coherent light sources generate coherent light with a coherence length such that superposition, e.g. interference, between the measurement beam, which is reflected by the object, and the reference beam is made possible.

In some embodiments, superposition of the measurement beam, which was reflected by the surface of the object, with the reference beam takes place before the first and second images are recorded. As a result, an interference pattern may be generated for each recording, which interference pattern is formed from the wave optical superposition of the reflected measurement beam and the reference beam. The coherent light of the first or second coherent light source advantageously makes superposition between the measurement beam, which was reflected by the surface of the object, and the reference beam possible.

In some embodiments, the recording of the second image takes place using the second coherent light source or using the first coherent light source, wherein in that case the phase difference between the measurement beam, which is generated using the first coherent light source, and the reference beam is changed using the phase shifter. In other words, to record the second image, a change in superposition may take place before the recording of the first image, wherein the change takes place using the phase shifter or using a coherent light source (second coherent light source) that differs from the first coherent light source.

Owing to the reflection of the measurement beam at the surface of the object, the reflected measurement beam has coherent and incoherent components. The coherent component alone of the reflected measurement beam makes a significant contribution to the interference. As a result, it is mainly the regions within the images that were formed in each case by coherent superposition that change from the first image to the second image. The incoherent components, for example the incoherent ambient light which is also formed on the images by way of recording, and/or the light of the measurement beam that is scattered within a volume of the object (volume scattering), on the other hand, on average do not change from the first to the second image. The volume-scattered light of the measurement beam is here incoherent because it has no more fixed reference with respect to its original phase owing to the multiple scattering within the volume of the object.

In some embodiments, the coherent components may be separated from the incoherent components, for example from the ambient light and/or from the component of the light that is scattered within the volume of the object (volume scattering), by evaluating the first and second images, which is performed using the calculation apparatus. However, the coherent components are mainly determined by the projected optical pattern, with the result that overall better recognition of the optical pattern and consequently improved depth determination of the object can be performed.

In some embodiments, the ambient light and the volume-scattered light of the measurement beam do not interfere with the reference beam. As a result, the incoherent component of the light remains on average approximately constant when recording the first and second images. The coherent component, on the other hand, changes due to the superposition between the first and the second image, with the result that said component can be identified exactly by said change in the evaluation. As a consequence, depth determination at ambient light and/or in semi-transparent objects, e.g. in organic tissue, is improved. This is of particular advantage in minimally invasive surgery, for example laparoscopies.

An example apparatus incorporating teachings of the present disclosure may comprise:

a capture apparatus, a calculation apparatus, and a projection apparatus, which comprises at least one first coherent light source;

wherein the projection apparatus comprises a first beam splitter which is configured to generate, by way of the first coherent light source, a measurement beam and a reference beam;

wherein the projection apparatus is furthermore configured to project an optical pattern, which is generated using the measurement beam, onto a surface of an object;

wherein a second beam splitter is provided, which makes possible superposition of the measurement beam, which was reflected by the surface of the object, and the reference beam;

wherein the capture apparatus is configured to record a first image, generated by the superposition, and a second image;

wherein the calculation apparatus is configured to evaluate the first and the second image for determining the depth of the object; and the apparatus comprises a second coherent light source, which is incoherent with respect to the first coherent light source, or a phase shifter,

wherein the second coherent light source is provided for recording the second image; or

wherein the phase shifter is configured for changing the phase difference between the measurement beam and the reference beam of the first coherent light source.

In some embodiments, subtraction of the first and second images is carried out in the evaluation of the first and second images. Generating a difference image, which is obtained for example by forming the absolute value of the difference of the first and second images, is referred to as subtraction of the two images. Here, the images are present for example as intensity images in the calculation apparatus. In other words, the first and the second image can be present as a matrix of intensity values. Said intensity values are then subtracted from one another using the calculation apparatus. Since the intensity values that correspond to the incoherent component of the light remain approximately constant on average, they drop out in the formation of the subtraction or are at least significantly reduced. The intensity values that correspond to the coherent component of the light and thus substantially to the optical pattern, on the other hand, remain in the difference image and can even be increased owing to the interference. In other words, the difference image formed by the subtraction forms an image of the projected optical pattern that has been purged of the ambient light and the volume-scattered component of the projected light (incoherent component) and makes possible improved depth determination of the object.

A change in the coherent component can additionally result from a movement and/or vibration of the object. A movement and/or vibration of the object in the range of the wavelength of the light which is generated by the first or second light source may be particularly advantageous here. By way of example, the movement and/or vibration of the object lies in the range of micrometers. Such a natural movement and/or vibration and an associated change in the coherent component exist for example in the case of organic tissue, in particular in minimally invasive surgery. A phase shift and consequently a change in the superposition of the measurement beam and the reference beam may occur due to the movement and/or vibration of the object. Corresponding to the change in the superposition, a change from the first to the second image takes place, which is in turn taken into consideration in the evaluation of the images, for example by forming the difference image. In other words, the object itself represents the phase shifter or a further phase shifter.

The regions of the image that are relevant for the evaluation and the depth determination of the object, in particular regions of the difference image, can generally increase or reduce in terms of their intensity due to constructive or destructive interference. It is therefore expedient to adapt the superposition between the measurement beam and the reference beam such that maximum constructive or destructive interference of the two beams mentioned occurs for the mentioned relevant regions of the difference image. As a result, the recognizability of the change between the first and second image, and consequently the recognizability of the optical pattern, are improved. Provision can additionally be made for the recording of a plurality of first and/or second images and their evaluation to improve the signal-to-noise ratio.

In some embodiments, a random or coded optical dot pattern is used as the optical pattern. An optical dot pattern may permit superposition of the measurement beam with the reference beam. This is because the position of a dot in the dot pattern changes only slightly within the optical dot pattern in the case of the reflection at the object. This results in only minor optical path length differences, with the result that an approximately constructive superposition of the dots within the first and second images takes place. As a result, the depth determination of the object may be further improved. Moreover, the randomness or the coding of the optical dot pattern permits the determination of the location of the individual dots within the reflected dot pattern relative to the projected dot pattern and consequently the addressing or at least improvement of the assignment problem in the depth determination of the object.

In some embodiments, a color-coded optical pattern is used as the optical pattern. In other words, color-coded triangulation of the object may take place. In some embodiments, there is a laser projector that has at least the colors red, green and blue (RGB laser projector). A 3-chip camera can here be provided for recording the first and second images. In other words, the capture apparatus comprises a 3-chip camera.

In some embodiments, the first and second images are recorded with a time lag with respect to one another. As a result, the phase difference can be adapted within the time lag between the recording of the first and second images. In addition, switching between the first and second coherent light sources is made possible. In some embodiments, the time lag can be adapted to the movement and/or vibration of the object. In other words, the first and the second image are recorded with a time lag with respect to one another that is dimensioned such that the change in position of the object is in the range of half-integer or integer multiples of the wavelength of the projected light. As a result, superposition between the reflected measurement beam and the reference beam is obtained, which noticeably changes between the recording of the first image and the recording of the second image.

In some embodiments, the recording of the first or second image is synchronized, by a control apparatus, with the use of the first or second coherent light source. In other words, switching on or off of the first and/or second coherent light source may be synchronized with the recording of the first or second image. For example, the first coherent light source is switched on and the first image is recorded. Using the control apparatus, the first coherent light source is subsequently switched off and the second coherent light source is switched on, and the second image is recorded using the capture apparatus. In other words, the control apparatus permits control of the first and/or second coherent light source and of the capture apparatus.

In some embodiments, the recording of the first or second image can be synchronized, by a control apparatus, with the change in the phase difference. As a result, the recording of the first or second image may be adapted to the changes in the phase difference. For example, the control apparatus makes possible control of the phase shifter such that a desired change in the phase difference between the measurement beam and the reference beam takes place. Here, the change in the phase difference and recording of a plurality of corresponding images can take place substantially continuously (sequence of images). As a result, approximately continuously capturing the change in the interference from destructive to constructive interference becomes possible. For example, the phase difference can to this end be modulated periodically with a reference frequency, with the result that particularly weak signals within the images can be detected by way of the evaluation of a plurality of first and/or second images, in particular a sequence of first and/or second images (sequence of images), and using a lock-in method. This is because the sequence of images can be filtered using a filter, the passband of which is mainly in the range of the reference frequency, with the result that components that deviate from said reference frequency, for example noise components, can be suppressed.

In some embodiments, a first laser is used as the first coherent light source and/or a second laser is used as the second coherent light source. The light from a laser, in particular from the first and second laser, may exhibit a high temporal coherence. The coherence length of the light of a laser is typically in the range of several meters. In addition, the light from a laser has a very high spatial coherence. Owing to the high temporal and spatial coherence of the light of a laser, lasers are particularly preferred as the first and/or second coherent light source.

In some embodiments, a piezotranslator or a Pockels cell is used as a phase shifter. A piezotranslator or a Pockels cell may allow adaptation of and change in the phase difference between the measurement beam and the reference beam. Here, the reference beam may travel through the piezotranslator or the Pockels cell. An advantage of the Pockels cell is that the light from the first coherent light source can be adapted or modulated continuously in terms of its phase. In particular, adaptation or modulation of the polarization and/or intensity is additionally possible.

In some embodiments, the first and/or second beam splitter is in the form of a splitter mirror. A splitter mirror may provide simple and cost-effective splitting of the light coming from the first or second coherent light source into the measurement beam and the reference beam. One component of the light coming from the first or second coherent light source is reflected by the splitter mirror. Another component is transmitted. The reflected component for example forms the measurement beam, and the transmitted component forms the reference beam. Further optical beam splitters for splitting the light coming from the first or second coherent light source into the measurement beam and the reference beam can be provided.

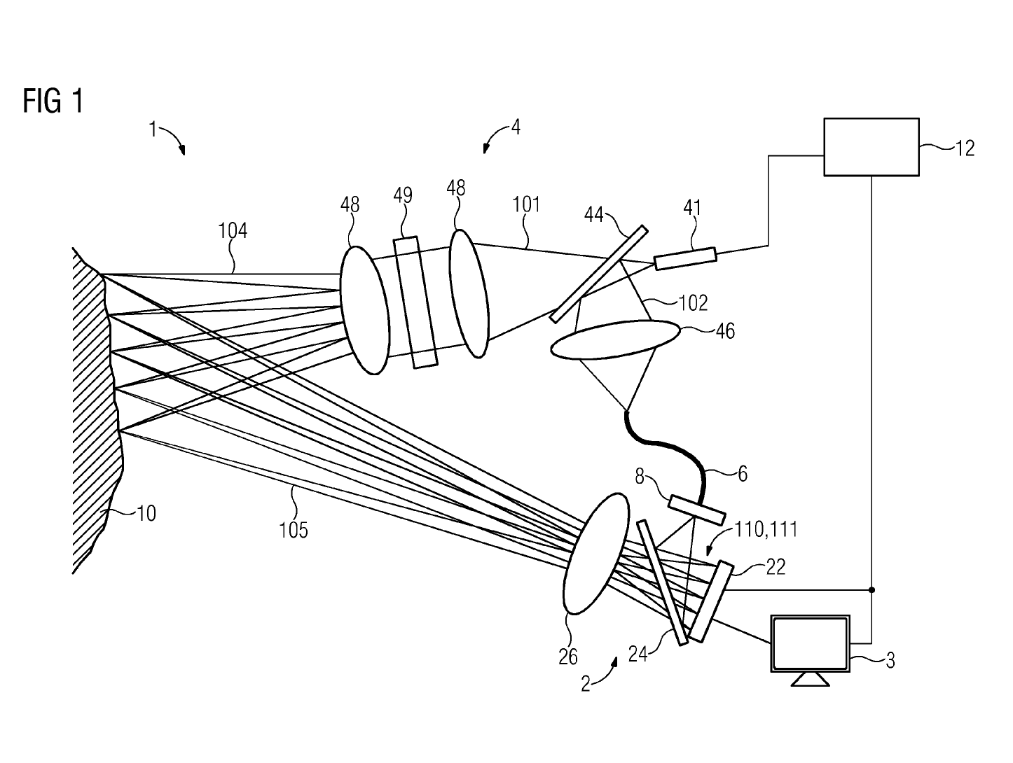

FIG. 1 shows an example apparatus 1 incorporating teachings of the present disclosure. The apparatus 1 comprises a projection apparatus 4, a capture apparatus 2, and a calculation apparatus 3. The apparatus 1 furthermore comprises a control apparatus 12. The projection apparatus 4 comprises a first coherent light source 41, a first beam splitter 44, a focusing lens 46, further lenses 48 and a diffractive optical element 49 (DOE). The apparatus 1 furthermore comprises an optical fiber 6, e.g. a single-mode optical fiber, and a phase shifter 8.

Coherent light from the first coherent light source 41 is split, using the first beam splitter 44, into a measurement beam 101 and a reference beam 102. The first coherent light source 41 is here in the form of a first laser. The measurement beam 101 generated is shaped, using the further lenses 48 and using the diffractive optical element 49, into an optical dot pattern 104. The shaping or forming of the optical dot pattern 104 is here performed diffractively, by way of diffraction of the measurement beam 101 at the diffractive optical element 49. The dot pattern 104, which is generated by the diffractive optical element 49, is subsequently projected onto a surface of an object 10, designated for depth determination, using the projection apparatus 4.

To record the measurement beam 105 reflected by the surface of the object 10 (reflected dot pattern), the capture apparatus 2 has at least one lens 26 and a second beam splitter 24 and a camera 22.

The first beam splitter 44 is used to form the reference beam 102 from the light of the first coherent light source 41. The reference beam 102 is focused, downstream of the first beam splitter 44, onto the input of the optical fiber 6 by way of the focusing lens 46. The reference beam 102 is guided, using the optical fiber 6, to the phase shifter 8. The phase shifter 8 is arranged at the output of the optical fiber 6. The reference beam 102 travels through the phase shifter 8. The phase shifter 8 is used to change the phase of the reference beam 102 or to shift it such that the phase difference between the measurement beam 101 and the reference beam 102 and/or between the reflected measurement beam 105 and the reference beam 102 is changed.

In some embodiments, before a first and second image is recorded using the camera 22, the reference beam 102, which is phase-shifted downstream of the phase shifter 8, is brought to superposition 111 with the measurement beam 105, which was reflected by the surface of the object 10, in a region 110. In other words, the superposition 111 of the reflected measurement beam 105 and the reference beam 102 takes place before the first and second images are recorded. To this end, the reference beam 102 is reflected at the second beam splitter 24 of the capture apparatus 2. By contrast, the measurement beam 105, which was reflected by the object 10, is mainly transmitted at the second beam splitter 24 of the capture apparatus 2.

In some embodiments, to record the first image, a phase difference between the measurement beam 101, 105 and the reference beam 102, is fixed using the phase shifter 8. To record the second image, the phase of the reference beam 102 is changed with respect to the phase of the measurement beam 101, 105 using the phase shifter 8. In other words, the phase difference between the measurement beam 101, 105 and the reference beam 102 is changed. Since said change in phase difference between the first and second image is not relevant for the incoherent component, the latter is on average the same in the first and second image.

By contrast, the coherent component in the first and second image is sensitive to the change in phase difference between the measurement beam 101, 105 and the reference beam 102, with the result that a significant change between the first and second image takes place. As a consequence, by changing the phase difference, approximately only the coherent component noticeably changes within the first and second image. As a result, the coherent component, which substantially corresponds to the projected optical dot pattern 104, can be recognized by way of its change from the first to the second image, as a result of which the depth determination of the object 10 is improved.

In some embodiments, the control apparatus 12 synchronizes the recordings of the first and/or second image and the change in the phase difference between the measurement beam 101, 105 and the reference beam 102 using the phase shifter 8. The control apparatus 12 can be electronically connected to the phase shifter 8, to the camera 22 and to the calculation apparatus 3. The camera 22 can furthermore be electronically connected to the calculation apparatus 3, which permits evaluation of the first and second images, in particular subtraction of the first and second images.

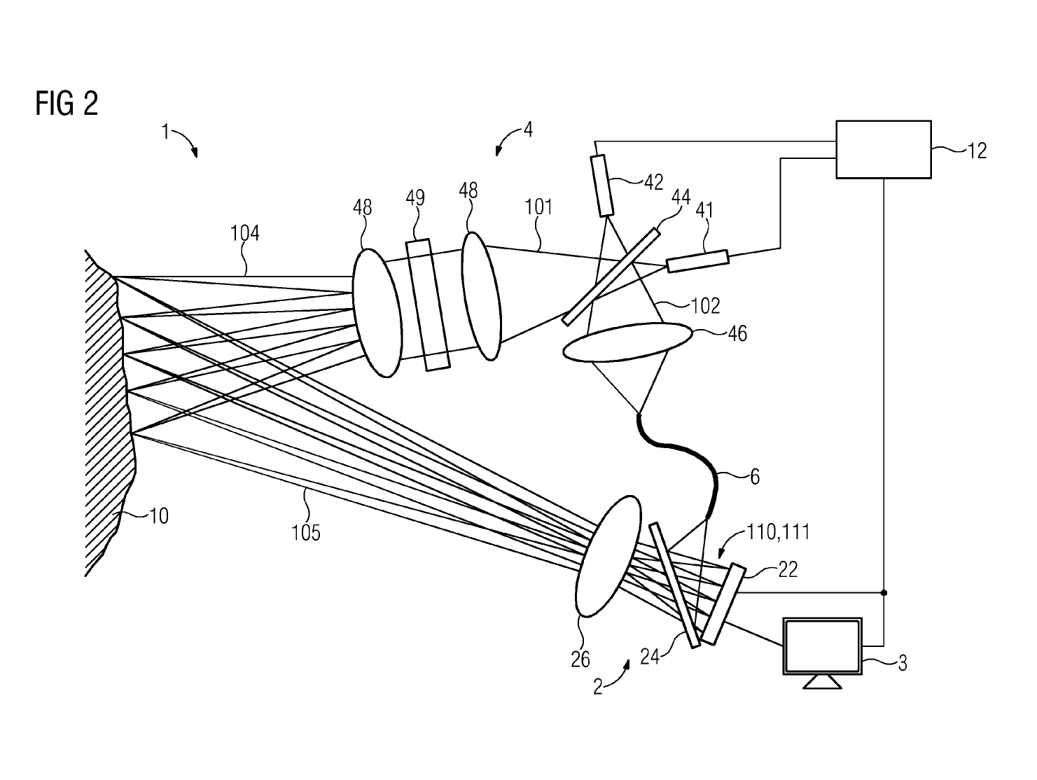

FIG. 2 shows an example of the further apparatus 1, incorporating teachings of the present disclosure. The further apparatus 1 comprises a projection apparatus 4, a capture apparatus 2, a calculation apparatus 3 and a control apparatus 12. The projection apparatus 4 comprises, in contrast to FIG. 1, a first and second coherent light source 41, 42. The method is in principle comparable, with respect to the first or second light source 41, 42, to the method already described in FIG. 1. In contrast to FIG. 1, rather than using a phase difference between a measurement beam 101, 105 and a reference beam 102 that is generated by way of the phase shifter 8, a phase difference that is comparable thereto is made possible by using the second coherent light source 42.

In some embodiments, the light generated by the first coherent light source 41 is incoherent with respect to the light from the second coherent light source 42. This is the case because no fixed phase relationship is present between the first and the second coherent light source 41, 42. In other words, two coherent light sources 41, 42 are used which are independent from one another with respect to their phase. In particular, the coherent light sources 41, 42 are in the form of lasers. Each of the coherent light sources 41, 42 generates a measurement beam 101 and a reference beam 102 using a first beam splitter 44 for recording an image. In other words, coherent light, which is generated by the coherent light sources 41, 42, is split into in each case a measurement beam 101 and a reference beam 102.

In some embodiments, the measurement beam 101 from the first or second coherent light source 41, 42 is transformed, using in each case lenses 48 and a diffractive optical element 49 (DOE), into an optical dot pattern 104. The optical dot pattern 104 is projected onto the surface of the object 10 using the projection apparatus 4. The dot pattern, which was reflected by the surface of the object 10, or the measurement beam 105, which was reflected by the surface of the object 10, is captured, via a lens 26 and a second beam splitter 24 of the capture apparatus 2, by a camera 22.

In some embodiments, the first coherent light source 41 is provided for recording the first image, such that the measurement beam 101, 105 and the reference beam 102 are generated using the first coherent light source 41 for recording the first image. By contrast, the second coherent light source 42 is provided for recording the second image, such that the measurement beam 101, 105 and the reference beam 102 are now generated using the second coherent light source 42 for recording the second image. In particular, the first coherent light source 41 may be switched on and the second coherent light source 42 switched off for the first image. For recording the second image, the first coherent light source 41 is switched off and the second coherent light source 42 is switched on.

In some embodiments, the reference beam 102 is focused, using a focusing lens 46, onto an input of an optical fiber 6, in particular an optical single-mode fiber. Here, the optical fiber 6 guides the reference beam 102 into a region 110 that is arranged in front of the camera 22 and is provided for superposition 111 of the reflected measurement beam 105 with the reference beam 102. In other words, superposition 111 and/or interference between the reflected measurement beam 105 and the reference beam 102, takes place in each case before and for the recording of the first and second images using the camera 22.

Since the coherent light sources 41, 42 have no fixed phase relationship with respect to one another, a phase difference occurs between the recording of the first image and the recording of the second image. The components of the images that were formed using a coherent component of the reflected measurement beam 105 change between the first image and the second image on account of said phase difference. The coherent component, however, substantially corresponds to the projected dot pattern 104, with the result that the latter can preferably be recognized due to the change between the first and the second image. An incoherent component of the reflected measurement beam 105, which is formed for example by ambient light or volume scattering inside the object 10, on average remains the same between the first and second image. As a result, the incoherent component can drop out or be significantly reduced in an evaluation by the calculation apparatus 12, for example by forming a difference image (subtraction of the first and second images). Consequently, the coherent component that is relevant for the evaluation is advantageously filtered out of a background (incoherent component).

In some embodiments, the control apparatus 12 provides synchronization, in particular for the switching on and/or off of the first and second coherent light source 41, 42. The control apparatus 12 can be electronically connected to the calculation apparatus 3 and to the camera 22. The camera 22 is furthermore electronically connected to the calculation apparatus 3 for evaluating the first and second images. The control apparatus 12 permits, for example in connection with the calculation apparatus 3, switching between the first coherent light source 41 and the second coherent light source 42.

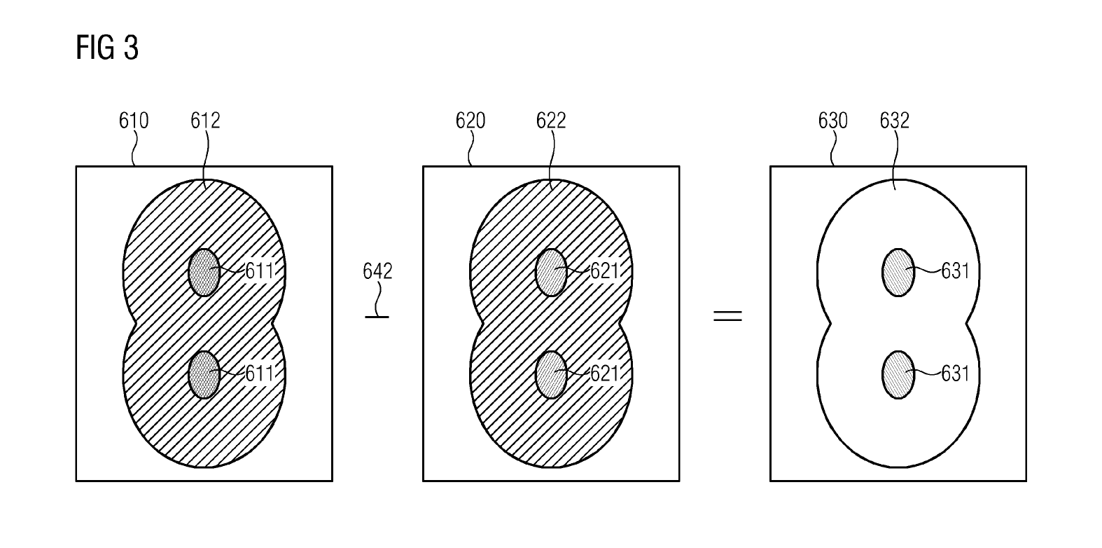

FIG. 3 illustrates an evaluation using subtraction 642 by way of example. Here, the subtraction 642 is formed using a first image 610 and a second image 620, as a result of which a difference image 630 is formed. The first image 610 and the second image 620 can be present in the form of matrices of intensity values in a memory of the calculation apparatus 3. In other words, the first and the second image 610, 620 are formed by a plurality of pixels, wherein each pixel is assigned at least one intensity value. The intensity value corresponds to the intensity of the light recorded using the camera 22.

In some embodiments, the measurement beam 101 is reflected at an organic tissue such that volume scattering of the measurement beam 101 occurs. As a result, the reflected measurement beam 105 in particular has an incoherent component 612. A coherent component 611 of the reflected measurement beam 105, which here substantially corresponds to a partial region of a dot pattern, is formed by two neighboring ellipsoidal regions. Due to the change in the phase difference between the recording of the first image 610 and the recording of the second image 620, the respective coherent components 611, 621 have different values with respect to their intensities. The respective incoherent components 612, 622, on the other hand, are approximately identical in the images 610, 620.

Using the subtraction 642 of the first and second images 610, 620, which is performed using the calculation apparatus 3, the approximately constant incoherent component 612, 622 drops out of the difference image 630. In other words, an incoherent component 632 of the difference image 630 is approximately equal to zero. Coherent components 631 of the difference image 630, which are formed from the coherent components 611, 621, on the other hand, can be significantly enhanced. In other words, the coherent components 631 of the difference image 630, which substantially correspond to the projected dot pattern 104, grow out of the incoherent component 632, i.e. the background. As a result, the depth determination of the object 10 may be improved and the signal-to-noise ratio is increased.

Although the teachings have been illustrated and described in detail by the exemplary embodiments, they are not limited by the disclosed examples, or other variations can be derived therefrom by the person skilled in the art without departing from the scope of protection of the following claims.

What is claimed is:

1. A method for determining the depth of an object, the method comprising:
generating a measurement beam and a reference beam with a first coherent light source;
projecting an optical pattern, generated from the measurement beam, onto a surface of the object by;
superposing the measurement beam reflected by the surface with the reference beam;
recording a first image resulting from the superposition using a sensor;
recording a second image; and
determining the depth of the object by evaluating the first and second images with a processor;
wherein:
for the recording of the second image,
rather than using the first coherent light source, a second coherent light source is used for generating the measurement beam and the reference beam, the second coherent light source incoherent with respect to the first coherent light source; or
a phase difference between the measurement beam and the reference beam of the first coherent light source is changed using a phase shifter.

2. The method as claimed in claim 1, further comprising forming a subtraction of the first and second images for evaluating the first and second images.

3. The method as claimed in claim 1, further comprising using a random or coded optical dot pattern as an optical pattern.

4. The method as claimed in claim 1, further comprising using a color-coded optical pattern as an optical pattern.

5. The method as claimed in claim 1, further comprising recording the first and second images with a time lag with respect to one another.

6. The method as claimed in claim 1, further comprising synchronizing in which the recording of the first or second image with the first or second coherent light source using a control apparatus.

7. The method as claimed in claim 1, further comprising synchronizing the recording of the first or second image, with the change in the phase difference with a control apparatus.

8. The method as claimed in claim 1, wherein at least one of the first and second coherent light sources comprises laser.

9. The method as claimed in claim 1, wherein the phase shifter comprising a piezotranslator or a Pockels cell.

10. An apparatus for determining the depth of an object, the apparatus comprising:
a sensor;
a processor;
a first coherent light source;
a first beam splitter configured to generate, using the first coherent light source, a measurement beam and a reference beam;
wherein the first beam splitter projects an optical pattern, using the measurement beam onto a surface of the object;
a second beam splitter superpositioning the measurement beam after reflecting from the surface of the object with the reference beam;
wherein the sensor records a first image generated by the superposition and a second image;
wherein the processor evaluates the first and the second image to determine the depth of the object; and
a second coherent light source incoherent with respect to the first coherent light source;
wherein the second coherent light source is used to generate the second image.

11. The apparatus as claimed in claim 10, wherein at least one of the first and second coherent light sources comprises a laser.

12. (canceled)

13. The apparatus as claimed in claim 10, wherein at least one of the first and second beam splitters comprises a splitter mirror.

14. An apparatus for determining the depth of an object, the apparatus comprising:
a sensor;
a processor;
a first coherent light source;
a first beam splitter configured to generate, using the first coherent light source, a measurement beam and a reference beam;
wherein the first beam splitter projects an optical pattern using the measurement beam onto a surface of the object;
a second beam splitter superpositioning the measurement beam after reflecting from the surface of the object with the reference beam;
wherein the sensor records a first image generated by the superposition and a second image;
wherein the processor evaluates the first and the second image to determine the depth of the object; and
a phase shifter changing the phase difference between the measurement beam and the reference beam of the first coherent light source.

15. The apparatus as claimed in claim 10, wherein the first coherent light source comprises a laser.

16. The apparatus as claimed in claim 13, wherein the phase shifter comprises a piezotranslator or a Pockels cell.

17. The apparatus as claimed in claim 13, wherein at least one of the first and second beam splitters comprises a splitter mirror.
